(19) United States
(12) Patent Application Publication
(10) Pub. No.: US 2008/0010065 A1
(43) Pub. Date: Jan. 10, 2008

(54) METHOD AND APPARATUS FOR SPEAKER RECOGNITION

(76) Inventors: Harry BRATT, Mountain View, CA (US); Luciana Ferrer, Palo Alto, CA (US); Martin Graciarena, Menlo Park, CA (US); Sachin Kajarekar, Mountain View, CA (US); Elizabeth Shriberg, Berkeley, CA (US); Mustafa Sonmez, Menlo Park, CA (US); Andreas Stolcke, Berkeley, CA (US); Gokhan Tur, Fremont, CA (US); Anand Venkataraman, Palo Alto, CA (US)

Correspondence Address: PATTERSON & SHERIDAN, LLP;SRI INTERNATIONAL, 595 SHREWSBURY AVENUE, SUITE 100, SHREWSBURY, NJ, 07702, US

(21) Appl. No.: 11/758,650

(22) Filed: Jun. 5, 2007

Related U.S. Application Data
(60) Provisional application No. 60/803,971, filed on Jun. 5, 2006.
(60) Provisional application No. 60/823,245, filed on Aug. 22, 2006.
(60) Provisional application No. 60/864,122, filed on Nov. 2, 2006.

(51) Int. Cl. G10L 17/00

(52) U.S. Cl. 704/246; 704/E15.002

(57) ABSTRACT

A method and apparatus for speaker recognition is provided. One embodiment of a method for determining whether a given speech signal is produced by an alleged speaker, where a plurality of statistical models (including at least one support vector machine) have been produced for the alleged speaker based on a previous speech signal received from the alleged speaker, includes receiving the given speech signal, the speech signal representing an utterance made by a speaker claiming to be the alleged speaker, scoring the given speech signal using at least two modeling systems, where at least one of the modeling systems is a support vector machine, combining scores produced by the modeling systems, with equal weights, to produce a final score, and determining, in accordance with the final score, whether the speaker is likely the alleged speaker.

### CROSS REFERENCE TO RELATED APPLICATIONS

This application claims the benefit of U.S. Provisional Patent Applications Ser. No. 60/803,971, filed Jun. 5, 2006; Ser. No. 60/823,245, filed Aug. 22, 2006; and Ser. No. 60/864,122, filed Nov. 2, 2006. All of these applications are herein incorporated by reference in their entireties.

### REFERENCE TO GOVERNMENT FUNDING

This invention was made with Government support under grant numbers IRI-9619921 and IIS-0329258 awarded by the National Science Foundation. The Government has certain rights in this invention.

### FIELD OF THE INVENTION

The present invention relates generally to the field of speaker recognition.

### SUMMARY OF THE INVENTION

A method and apparatus for speaker recognition is provided. One embodiment of a method for determining whether a given speech signal is produced by an alleged speaker, where a plurality of statistical models (including at least one support vector machine) have been produced for the alleged speaker based on a previous speech signal received from the alleged speaker, includes receiving the given speech signal, the speech signal representing an utterance made by a speaker claiming to be the alleged speaker, scoring the given speech signal using at least two modeling systems, where at least one of the modeling systems is a support vector machine, combining scores produced by the modeling systems, with equal weights, to produce a final score, and determining, in accordance with the final score, whether the speaker is likely the alleged speaker.

### BRIEF DESCRIPTION OF THE DRAWINGS

The teachings of the present invention can be readily understood by considering the following detailed description in conjunction with the accompanying drawings, in which:

FIG. 1 depicts one embodiment of a method for speaker recognition, according to the present invention;

FIG. 2 is a flow diagram illustrating one embodiment of a method for speaker recognition, according to the present invention;

FIG. 3 is a flow diagram illustrating a second embodiment of a method for speaker recognition, according to the present invention;

FIG. 4 is a schematic diagram illustrating the possible combinations of region, measure and normalization for the duration features;

FIG. 5 is a schematic diagram illustrating the possible combinations of region, measure and normalization for the pitch features;

FIG. 6 is a schematic diagram illustrating the possible combinations of region, measure and normalization for the energy features;

FIG. 7 illustrates a first embodiment of a method for transforming a set of syllable-level feature vectors into a single sample-level vector;

FIG. 8 illustrates a second embodiment of a method for transforming a set of syllable-level feature vectors into a single sample-level vector;

FIG. 9 is a flow diagram illustrating another embodiment of a method for training background GMMs for tokens;

FIG. 10 is a flow diagram illustrating a third embodiment of a method for speaker recognition, according to the present invention; and

FIG. 11 is a high-level block diagram of the inventive collaborative user interface that is implemented using a general purpose computing device.

To facilitate understanding, identical reference numerals have been used, where possible, to designate identical elements that are common to the figures.

### DETAILED DESCRIPTION

The present invention relates to a method and apparatus for speaker recognition (i.e., determining the identity of a person supplying a speech signal). Specifically, the present invention provides methods for discerning between a target (or true) speaker and one or more impostor (or background) speakers. Given a sample speech input from a speaker and a claimed identity, the present invention determines whether the claim is true or false. Embodiments of the present invention combine novel acoustic and stylistic approaches to speaker modeling by fusing scores computed by individual models into a new score, via use of a “combiner” model.

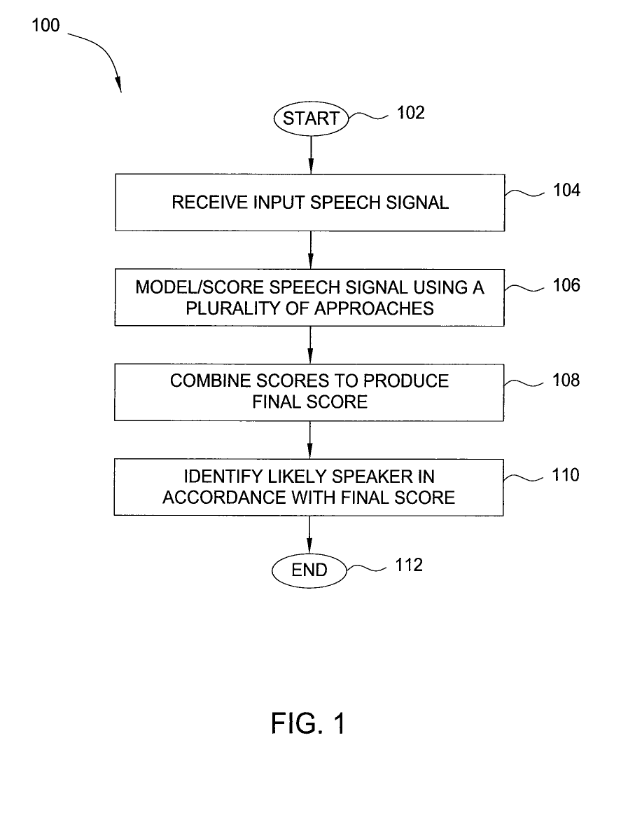

FIG. 1 depicts one embodiment of a method 100 for speaker recognition, according to the present invention. The method 100 is initialized at step 102 and proceeds to step 104, where the method 100 receives an input speech signal (utterance) from a speaker. The speaker is either a target speaker or an impostor.

In step 106, the method 100 models the speech signal using a plurality of modeling approaches. The result is a plurality of scores, generated by the different approaches, indicating whether the speech signal likely came from the target speaker or likely came from an impostor. In one embodiment, each of the plurality of modeling approaches is a support vector machine (SVM)-based discriminative modeling approach. Each SVM is trained to classify between features for a target speaker, and features for impostors (where there are more instances—on the order of thousands—for impostors than there are instances—up to approximately eight—for true speakers). In one embodiment, the method 100 produces four individual scores (models) in step 106 (i.e., using four SVMs). In one embodiment, the SVMs use a linear kernel and differ in the types of features. Moreover, the SVMs use a cost function that makes false rejection more costly than false acceptance. In one embodiment, false rejection is five hundred times more costly than false acceptance.

In step 108, the method 100 combines the scores produced in step 106 to produce a final score. The final score indicates a “consensus” as to the likelihood that the speaker is the target speaker or an impostor. In one embodiment, the scores are combined with equal weights.

In step 110, the method 100 identifies the likely speaker, based on the final score produced in step 108. Specifically, the method 100 classifies the input speech signal as coming from either the target speaker or an impostor. The method 100 then terminates in step 112.

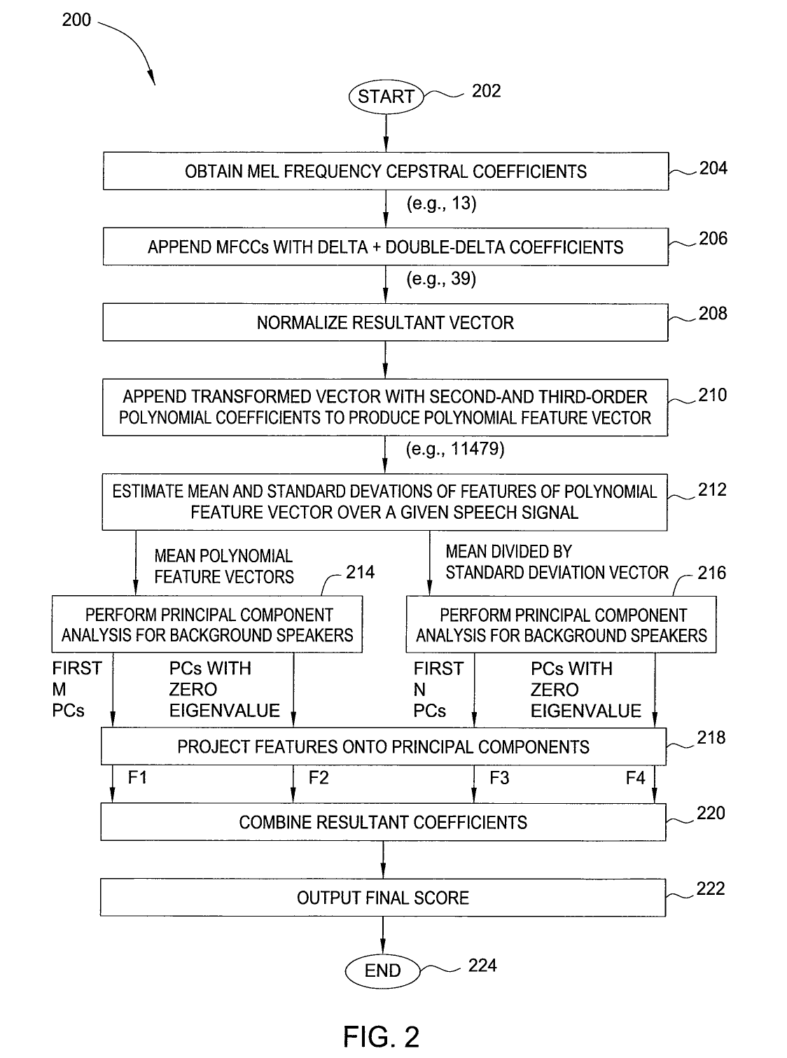

FIG. 2 is a flow diagram illustrating one embodiment of a method 200 for speaker recognition, according to the present invention. Specifically, the method 200 facilitates a variant of the method 100 that relies on acoustic modeling to recognize speakers. More specifically, the method 200 is one embodiment of a method for generating a score for an input speech signal (e.g., in accordance with step 108 of the method 100) by estimating polynomial features for use by SVMs in recognizing speakers.

The method 200 represents cepstral features of an input speech signal by combining a subspace spanned by training speakers (for whom normalization statistics are available) with the subspace's complementary space, modeling both subspaces separately with SVMs, and then combining the systems. Specifically, when polynomial features (on the order of tens of thousands) are used as features with an SVM, a peculiar situation arises. Since there are more features than impostor speakers (on the order of thousands, as discussed above), the distribution of features in a high dimensional space lies in a lower dimensional subspace spanned by the background (or impostor) speakers. This lower dimensional subspace is referred to herein as the “background subspace”. A subspace orthogonal to the background subspace captures all the variation in the feature space that is not observed between background speakers. This orthogonal subspace is referred to herein as the “background-complement subspace”. It is evident that the background subspace and the background-complement subspace have different characteristics for speaker recognition.

Referring back to FIG. 2, the method 200 is initialized at step 202 and proceeds to step 204, where the method 200 obtains Mel frequency cepstral coefficients (MFCCs). In one embodiment, the method 200 obtains thirteen MFCCs. In one embodiment, the MFCCs are estimated by a 300 to 3300 Hz bandwidth front end comprising 19 Mel filters.

In step 206, the method 200 appends the MFCCs with delta and double-delta coefficients, tripling the number of dimensions (e.g., to a 39-dimensional feature vector in the current example, where the method 200 starts with 13 MFCCS). The method 200 then proceeds to step 208 and normalizes the resultant vector, in one embodiment using cepstral mean subtraction (CMS) and feature transformation to mitigate the effects of handset variation (e.g., variation in the means by which the user speech signal is captured).

In step 210, the method 200 appends the transformed vector with second order and third order polynomial coefficients, where the second order polynomial of X=[x₁ x₂π is poly(X,2)=[X x₁² x₁x₂ x₂²π and the third order polynomial is poly(X,3)=[p(X,2) x₁³ x₁²x₂ x₁x₂²x₂³]. If the method 200 originally obtained thirteen MFCCs in step 202, then the resultant vector, referred to as the “polynomial feature vector”, will have 11479 dimensions.

In step 212, the method 200 estimates the mean and standard deviations of the features of the polynomial feature vector over a given speech signal (utterance).

At this point, the method 200 branches into two individual processes that are performed in parallel. In the case where four SVMs are used to process the speech signal, the first two of the SVMs use the mean polynomial (MP) feature vectors for further processing, while the second two SVMs use the mean polynomial vector divided by the standard deviation polynomial vector (MSDP), as discussed in further detail below.

For the first two SVMs, the method 200 proceeds to step 214 and performs principal component analysis (PCA) on the polynomial features for the background (impostor) speaker utterances. The number, F, of features (e.g., F=11479 in the current example) is much larger than the number, S, of background speakers (S=on the order of thousands, as discussed above). Thus, the distribution of high-dimensional features lies in a lower dimensional speaker subspace. Only S−1 leading eigenvectors (also referred to as principal components (PCs)) have non-zero eigenvalues. The remaining F-S+1 eigenvectors have zero eigenvalues. The leading eigenvectors are normalized by the corresponding eigenvalues. All of the leading eigenvectors are selected because the total variance is distributed evenly across them.

The method 200 then proceeds to step 218 and projects features onto principal components. Specifically, the mean polynomial features are projected onto the normalized S−1 eigenvectors (F1), and onto the remaining F-S+1 un-normalized eigenvectors (F2).

Referring back to step 212, the second two SVMs modify the kernel to include a confidence estimate obtained from the standard deviation. If X̅ and Y̅ are two mean polynomial vectors, the kernel used in the first two SVMs can be described as:
k( X̅, Y̅)= X̅^{T} Y̅=Σ x̅ᵢ y̅ᵢ (EQN. 1)
This kernel may be modified as:

$$k ( \overline{X} , \overline{Y} ) = \sum \frac{{\overline{x}}_{i}}{{σ}_{{x}_{i}}} \frac{{\overline{y}}_{i}}{{σ}_{{y}_{i}}} = {\overline{X}}_{1}^{T} {\overline{Y}}_{1} \qquad ( EQN . 2 )$$

This implies that the inner product is scaled by the standard deviation of the individual features, where the standard deviation is computed separately over each utterance. Instead of modifying the kernel, the features are modified by obtaining a new feature vector that is the mean polynomial vector divided by the standard deviation polynomial vector (MSDP).

For the second two SVMs, the method 200 proceeds to step 216 and performs principal component analysis (PCA) on the polynomial features for the background (impostor) speaker utterances. As in step 214, two sets of eigenvectors are obtained: the first set (F3) corresponds to non-zero eigenvalues, and the second set (F4) corresponds to zero eigenvalues. In the first set, the eigenvalues are not spread evenly, as they are for mean polynomial vectors. This is due to the scaling by the standard deviation terms. In one embodiment, only the first five hundred leading eigenvectors (corresponding to ninety-nine percent of the total variance) and use coefficients obtained from the first five hundred leading eigenvectors are kept in the first two SVMs. The second two SVMs use as features the coefficients obtained using the trailing eigenvectors corresponding to zero eigenvalues.

The method 200 then proceeds to step 218 as described above and projects features onto principal components. Specifically, the mean polynomial features are projected onto the normalized S−1 eigenvectors (F1), and onto the remaining F-S+1 un-normalized eigenvectors (F2).

In step 220, the method 200 combines the coefficients produced in step 218 (F1, F2, F3, and F4), which comprise complementary output, using a single (“combiner”) system. In one embodiment, the combiner is any system (e.g., SVM, neural network, etc.) that can use any linear or non-linear combination strategy. In one embodiment, the combiner SVM sums the scores from all of the SVMs (e.g., the four SVMs in the current example) with equal weights to produce the final score, which is output in step 222. The method 200 then terminates in step 224.

In one embodiment, the background and background-complement transforms are estimated as follows. The covariance matrix from the features (F) for background speakers (S) is a low-rank matrix having a rank S−1. Instead of performing PCA in feature space, PCA is performed in speaker space. This is analogous to kernel PCA. The S−1 kernel principal components are then transformed into the corresponding principal components in feature space. The principal components in feature space are divided by the eigenvalues to produce (S−1)*F background transforms.

The computation of a complement transform depends on the original transform that was used. Since PCA was performed in the previous step, the background-complement transform is implemented implicitly (PCA is a direct result of the inner product kernel). A given feature vector is projected onto the eigenvectors of the background transform. The resultant coefficients are used to reconstruct the feature vector in the original space. The difference between the original and reconstructed feature vectors is used as the feature vector in the background-complement subspace. This is an F-dimensional subspace. Those skilled in the art will appreciate that other embodiments of the present invention may not rely on PCA and complementary transforms, but may be extended to other techniques including, but not limited to, independent component analysis and local linear PCA (the complement will be computed accordingly). In other embodiments using non-linear kernels (e.g., radial basis function), the complement may be produced in a very different way.

An interesting property of the background-complement subspace is that all of the feature vectors corresponding to the background speakers get mapped to the origin. Thus, SVM training is very easy. The origin is a single impostor data point (irrespective of the number of impostors), and one or more transformed feature vectors from the target training data are the true speaker data points. This is very different from training in the background subspace, where there are S impostor data points and one or more target speaker data points.

The method 200 may be implemented independently (e.g., in an autonomous speaker recognition system) or in conjunction with other systems and methods to provide improved speaker recognition performance.

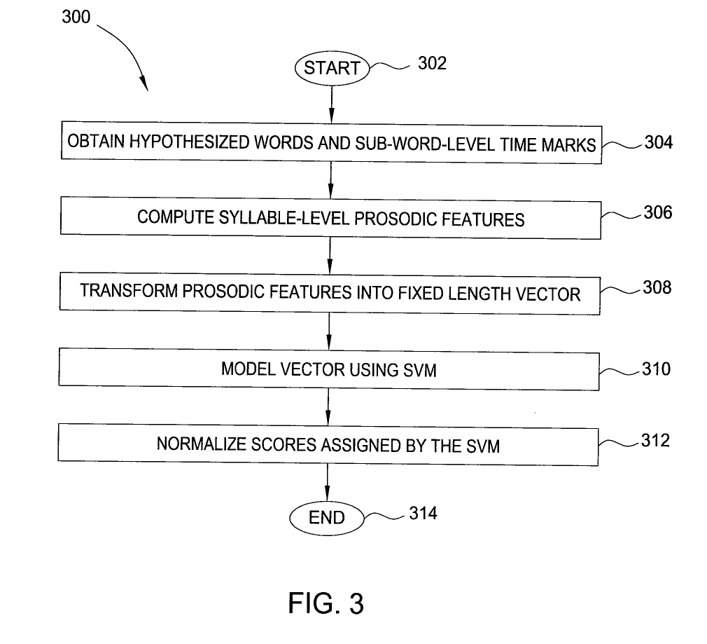

FIG. 3 is a flow diagram illustrating a second embodiment of a method 300 for speaker recognition, according to the present invention. Specifically, the method 300 facilitates a variant of the method 100 that relies on stylistic (specifically, prosodic) modeling to recognize speakers. More specifically, the method 300 is one embodiment of a method for generating a score for an input speech signal (e.g., in accordance with step 108 of the method 100) by modeling idiosyncratic, syllable-based prosodic behavior.

The method 300 performs modeling based on output from a word recognizer. That is, knowing what was said in a given speech signal (i.e., the hypothesized words), the method 300 aims to identify who said it by characterizing long-term aspects of the speech (e.g., pitch, duration, energy, and the like). The method 300 computes a set of prosodic features associated with each recognized syllable (syllable-based non-uniform extraction region features, or SNERFs), transforms them into fixed-length vectors, and models them using support vector machines (SVMs). Although the method 300 is described in terms of characterizing the pitch, duration, and energy of speech, those skilled in the art will appreciate that other types of prosodic features (e.g., jitter, shimmer) could also be characterized in accordance with the present invention for the purposes of performing speaker recognition.

Referring back to FIG. 3, the method 300 is initialized in step 302 and proceeds to step 304, where the method 300 obtains hypothesized words and their associated sub-word-level time marks. In one embodiment, this information is obtained from an automatic speech recognition system. It should be noted that the best speech recognition system as measured in terms of word error rate (WER) may not necessarily be the best system to use for obtaining hypothesized words and time marks for the purposes of speaker recognition. That is, more errorful speech recognition may result in better speaker recognition aimed at capturing basic prosodic patterns.

In step 304, the method 300 computes syllable-level prosodic features from the hypothesized words and time marks. In one embodiment, to estimate syllable regions, the method 300 syllabifies the hypothesized words and time marks using a program that employs a set of human-created rules that operate on the best-matched dictionary pronunciation for each word. For each resulting syllable region, the method 300 obtains phone-level alignment information (e.g., from the speech recognizer) and then extracts a large number of prosodic features related to the duration, pitch, and energy values in the syllable region. After extraction and stylization of these prosodic features, the method 300 creates a number of duration, pitch, and energy features aimed at capturing basic prosodic patterns at the syllable level.

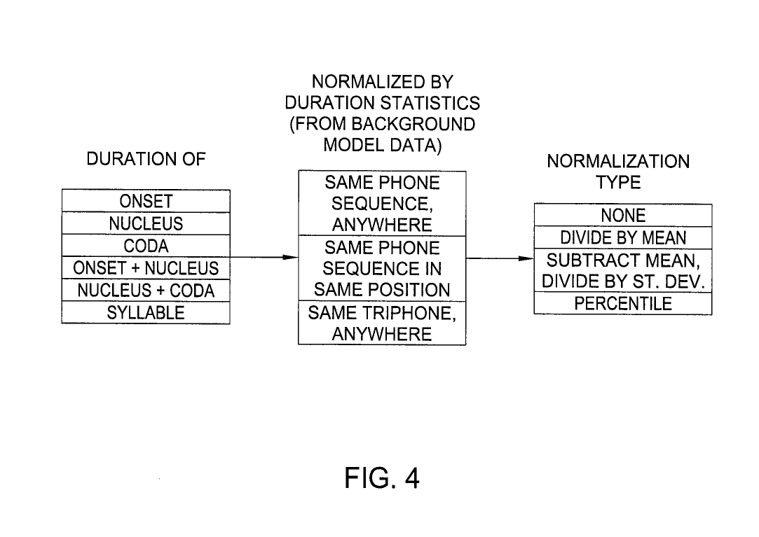

In one embodiment, for duration features, the method 300 uses six different regions in the syllable. As illustrated in FIG. 4, which is a schematic diagram illustrating the possible combinations of region, measure and normalization for the duration features, the six different regions are: the onset, the nucleus, the coda, the onset+nucleus, the nucleus+coda, and the full syllable. The duration for the syllable region is obtained and normalized using three different approaches for computing normalization statistics based on data from speakers in the background model. Instances of the same sequence of phones appearing in the same syllable position, the same sequence of phones appearing anywhere, and instances of the same triphones anywhere are used. These three alternatives are crossed with four different types of normalization: no normalization, division by the distribution mean, Z-score normalization ((value-mean)/standard deviation), and percentile. Not all combinations of region, measure and normalization are necessarily used.

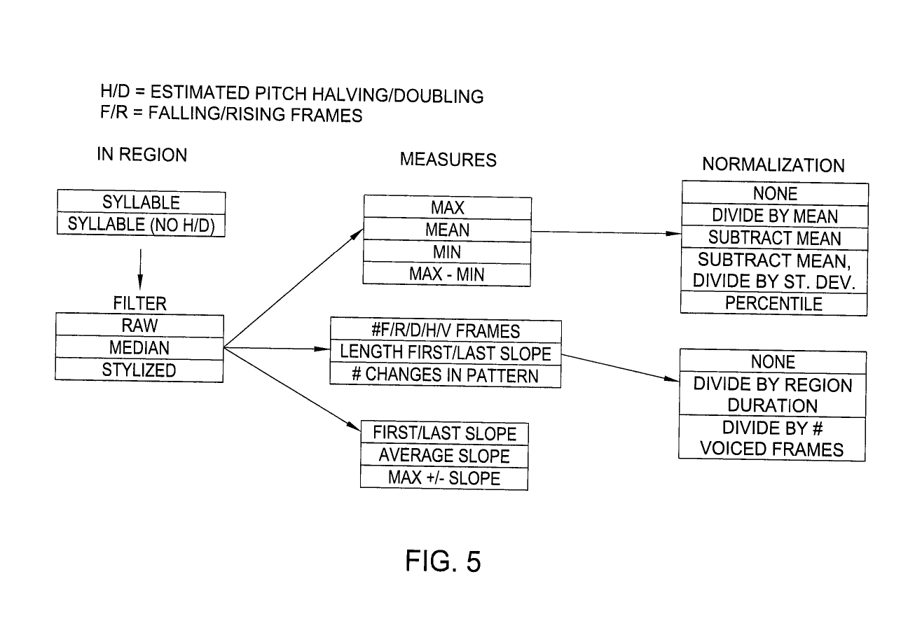

In one embodiment, for pitch features, the method 300 uses two different regions in the syllable. As illustrated in FIG. 5, which is a schematic diagram illustrating the possible combinations of region, measure and normalization for the pitch features, the two different regions are: the voiced frames in the syllable and the voiced frames ignoring any frames deemed to be halved or doubled by pitch post-processing. The pitch output in these regions is then used in one of three forms: raw, median-filtered, or stylized using a linear spline approach. For each of these pitch value sequences, a large set of prosodic features is computed, including: maximum pitch, mean pitch, minimum pitch, maximum minus minimum pitch, number of frames that are rising/falling/doubled/halved/voiced, length of the first/last slope, number of changes from fall to rise, value of first/last/average slope, and maximum positive/negative slope. Maximum pitch, mean pitch, minimum pitch, and maximum minus minimum pitch are normalized by five different approaches using data over an entire conversation side: no normalization, divide by mean, subtract mean, Z-score normalization, and percentile value, Features involving frame counts are normalized by both the total duration of the region and the duration of the region counting only voiced frames.

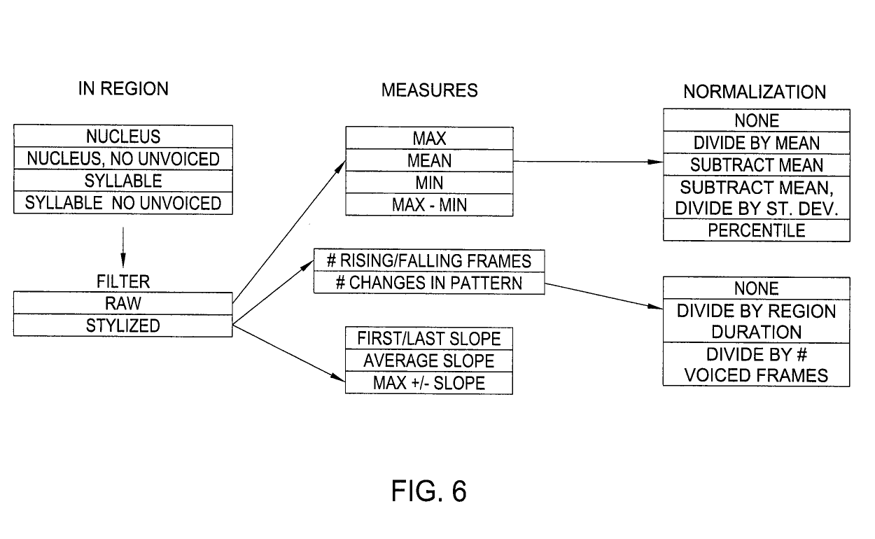

In one embodiment, for energy features, the method 300 uses four different regions in the syllable. As illustrated in FIG. 6, which is a schematic diagram illustrating the possible combinations of region, measure and normalization for the energy features, the four different regions are: the nucleus, the nucleus minus any unvoiced frames, the whole syllable, and the whole syllable minus any unvoiced frames. These values are then used to compute prosodic features in a manner similar to that described for pitch features, as illustrated in FIG. 6. Unlike the pitch case, however, un-normalized values for energy are not included, since raw energy magnitudes tend to reflect characteristics of the channel rather than of the speaker.

Referring back to FIG. 3, in step 308, the method 300 transforms the syllable-level prosodic features into a fixed-length (sample-level) vector b(X), as described in further detail below.

In step 310, the method 300 models the sample-level vector b(X) using an SVM. In one embodiment, the score assigned by the SVM to any particular speech signal is the signed Euclidean distance from the separating hyperplane to the point in hyperspace that represents the speech signal, where a negative value indicates an impostor. The output (score) is a real-valued number.

In step 312, the method 300 normalizes the scores assigned by the SVM. In one embodiment, the scores are normalized using an impostor-centric score normalization method. Specifically, each score is normalized by a mean and a variance, which are estimated by scoring the speech signal against the set of impostor models. The method 300 then terminates in step 314.

In some embodiments, as described above, the set of syllable-level feature vectors X={x₁, x₂, . . . , x₃} is transformed into a single sample-level vector b(X) for modeling by the SVM. Since linear kernel SVMs are trained, the whole process is equivalent to using a kernel given by K(X,Y)=b(X)^{t}b(Y). Each component of X corresponds to either a syllable or a pause, and these components are referred to as “slots”. If a slot corresponds to a syllable, it contains the prosodic features for that syllable. If a slot corresponds to a pause, it contains the pause length. The overall idea is to make a representation of the distribution of the prosodic features and then use the parameters of that representation to form the sample-level vector b(X). In one embodiment, each prosodic feature is considered separately and models are generated for the distribution of prosodic features in unigrams, bigrams, and trigrams. This allows the change in the prosodic features over time to be modeled. In another embodiment, the prosodic features are considered in groups.

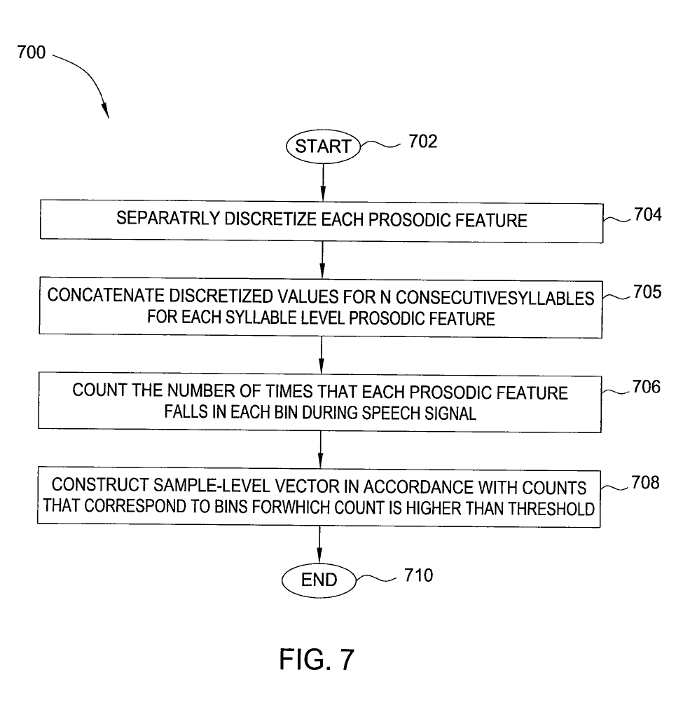

Furthermore, separate models are created for sequences including pauses in different positions of the sequence. For N=1 gram length (i.e., unigrams), each prosodic feature is modeled with a single model (S) including only non-pause slots (i.e., actual syllables). For N=2 gram length (i.e., bigrams), three different models are obtained: (S,S), (P,S) and (S,P) for each prosodic feature (where S represents a syllable and P represents a pause). For N=3 gram length (i.e., trigrams), five different models are obtained: (S,S,S), (P,S,S), (S,P,S), (S,S,P) and (P,S,P) for each prosodic feature. Each pair {prosodic feature, pattern} determines a “token”. The parameters corresponding to all tokens are concatenated to obtain the sample-level vector b(X). Three different embodiments of parameterizations of the token distributions, according to the present invention, are described in further detail with respect to FIGS. 7-9.

FIG. 7 illustrates a first embodiment of a method 700 for transforming a set of syllable-level feature vectors X={x₁, x₂, . . . , x₃} into a single sample-level vector b(X) (e.g., in accordance with step 308 of the method 300). The method 700 is initialized at step 702 and proceeds to step 704, where the method 700 parameterizes the token distributions by discretizing each prosodic feature separately. In step 705, the method 700 concatenates the discretized values for N consecutive syllables for each syllable-level prosodic feature.

The method 700 then proceeds to step 706 and counts the number of times that each prosodic feature fell in each bin during the speech signal. Since it is not known a priori where to place thresholds for binning data, discretization is performed evenly on the rank distribution of values for a given prosodic feature, so that the resultant bins contain roughly equal amounts of data, When this is not possible (e.g., in the case of discrete features), unequal mass bins are allowed. For pauses, one set of hand-chosen threshold values (e.g., 60, 150, and 300 ms) is used to divide the pauses into four different lengths. In this approach, the undefined values are simply taken to be a separate bin. The bins for bigrams and trigrams are obtained by concatenating the bins for each feature in the sequence. This results in a grid, and the prosodic features are simply the counts corresponding to each bin in the grid. In one embodiment, the counts are normalized by the total number of syllables in the sample/speech signal. Many of the bins obtained by simple concatenation will correspond to places in the feature space where very few samples ever fall.

The method 700 then proceeds to step 708 and constructs the sample-level vector b(X). The sample level vector b(X) is composed only of the counts corresponding to bins for which the count was higher than a certain threshold in some held-out data. The method 700 then terminates in step 710.

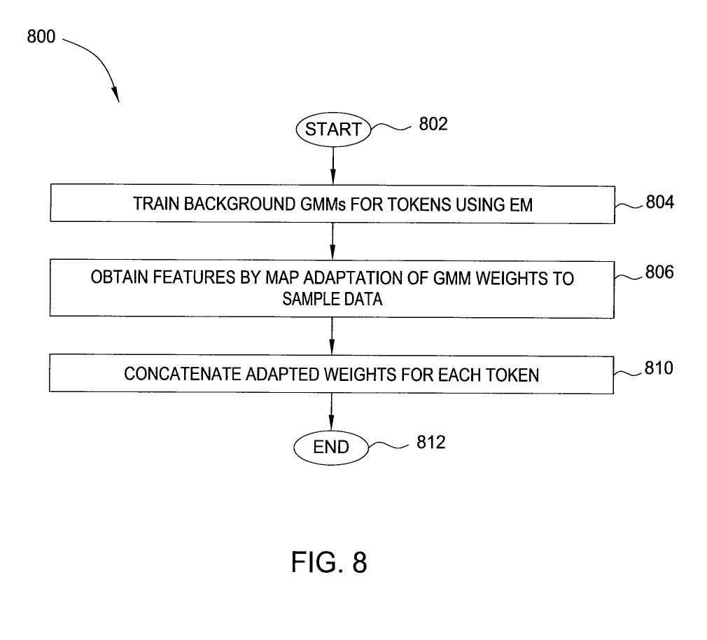

FIG. 8 illustrates a second embodiment of a method 800 for transforming a set of syllable-level feature vectors X={x₁, x₂, . . . , x₃} into a single sample-level vector b(X) (e.g., in accordance with step 308 of the method 300). According to the method 800, each token is modeled with a GMM, and the weights of the Gaussians are used to form the sample-level vector b(X). The method 800 is initialized at step 802 and proceeds to step 804, where a GMM is trained using the expectation-maximization (EM) algorithm (initialized using vector quantization, as described in further detail below, to ensure a good starting point) for each token, using pooled data from a few thousand speakers. The vectors used to train the GMM for a token corresponding to the feature fⱼ and pattern Q=(q₀, . . . , q_{N-1}) (where qᵢ is either P for pause or S for syllable) are of the form Yⱼ^{(t)}=(y_{j,0}^{(t)}, . . . , y_{j,N-1}^{(t)}), where t is the slot index (from 1 to T) and:

$${y}_{j , k}^{( t )} = \{ \begin{matrix} log ( {p}^{( t + k )} ) & if {q}_{k} = P \\ {f}_{j}^{t + k} & if k = 0 or {q}_{k - 1} = P \\ {f}_{j}^{t + k} - {f}_{j}^{( t + k - 1 )} & otherwise\end{matrix} \qquad ( EQN . 3 )$$

where pₜ is the length of the pause at slot t and fₜ is the value of the prosodic feature f at slot t. The logarithm is used to reflect the fact that the influence of the length of the pause decreases as the length of the pause itself increases. In this approach, discrete features are treated in the same way as continuous features, with the only precaution being that variances that become too small are clipped to a minimum value.

Once the background GMMs for each token have been trained, the method 800 proceeds to step 806 and obtains the features for each test and train sample by MAP adaptation of the GMM weights to the sample's data. The adapted weight is simply the posterior probability of a Gaussian given the feature vector, averaged over all syllables in the speech signal.

In step 808, the adapted weights for each token are finally concatenated to form the sample-level vector b(X). The method 800 then terminates in step 810.

For the one-dimensional case (i.e., unigrams), the method 800 is closely related to the method 700, with the “hard” bins replaced by Gaussians and the counts replaced by posterior probabilities. For longer N-grams, there is a bigger difference: the “soft” bins represented by the Gaussians are obtained by looking at the joint distribution from all dimensions, while in the method 700, the bins were obtained as a concatenation of the bins for the unigrams.

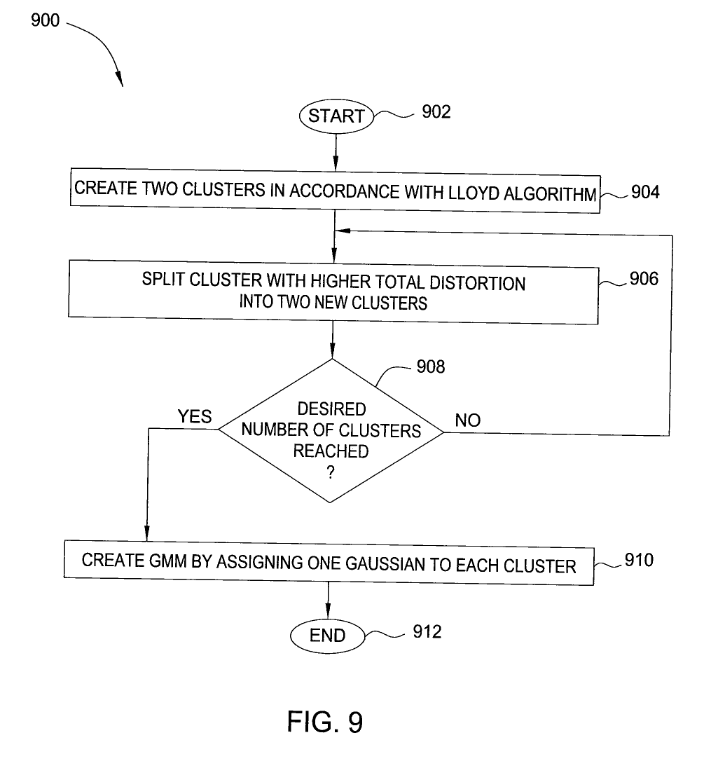

FIG. 9 is a flow diagram illustrating another embodiment of a method 800 for training background GMMs for tokens (e.g., in accordance with step 804 of FIG. 8). In the method 900, vector quantization (e.g., rather than EM) is used to train the background GMMs. The vectors used in this approach are defined as in the method 800 (i.e., by EQN. 3), and the final features for each sample are obtained by MAP adaptation of the background GMMs to the sample data (also as discussed with respect to the method 800).

A variation of the Linde Buzo Gray (LBG) algorithm (i.e., as described by Gersho et al. in “Vector Quantization and Signal Compression”, 1992, Kluwer Academic Publishers Group, Norwell, Mass.) is used to create the models. The method 900 is initialized in step 902 and proceeds to step 904, where the Lloyd algorithm is used to create two clusters (i.e., as also described by Gersho et al.).

In step 906, the cluster with the higher total distortion is then further split into two by perturbing the mean of the original cluster by a small amount. These clusters are used as a starting point for running a few iterations of the Lloyd algorithm.

In step 908, the method 900 determines whether the desired number of clusters has been reached. In one embodiment, the desired number of clusters is determined empirically (e.g., by cross validation). If the method 900 concludes that the desired number of clusters has not been reached, the method 900 returns to step 906 and proceeds as described above to split the new cluster with the higher total distortion into two new clusters. One cluster at a time is split until the desired number of clusters is reached. In one embodiment, during every step, the distortion used is weighted squares (i.e., d(x,y)=Σ(xᵢ−yᵢ)²/vᵢ), where vᵢ is the global variance of the data in the dimension i. When an undefined feature is present, the term corresponding to that dimension is simply ignored in the computation of distortion. If at any step a cluster is created that has too few samples, this cluster is destroyed, and a cluster with high total distortion is split in two.

Alternatively, if the method 900 concludes in step 908 that the desired number of clusters has been reached, the method 900 proceeds to step 910 and creates a GMM by assigning one Gaussian to each cluster with mean and variance determined by the data in the cluster and weight given by the proportion of samples in that cluster. This approach naturally deals with discrete values resulting in clusters with a single discrete value when necessary. The variances for these clusters are set to a minimum when converting the codebook to a GMM. The method 900 then terminates in step 912.

In one embodiment, the present invention may be implemented in conjunction with a word N-gram SVM-based system that outputs discriminant function values for given test vectors and speaker models. In accordance with this method, speaker-specific word N-gram models may be constructed using SVMs. The word N-gram SVM operates in a feature space given by the relative frequencies of word N-grams in the recognition output for a conversation side. Each N-gram corresponds to one prosodic feature dimension. N-gram frequencies are normalized (e.g., by rank-normalization, mean and variance normalization, Gaussianization, or the like) and modeled in an SVM with a linear kernel, with a bias (e.g., 500) against misclassification of positive examples.

In another embodiment, the present invention may be implemented in conjunction with a Gaussian mixture model (GMM)-based system that outputs the logarithm of the likelihood ratio between corresponding speaker and background models. In this case, three types of prosodic features are created: word features (containing the sequence of phone durations in the word and having varying numbers of components depending on the number of phones in their pronunciation, where each pronunciation gives rise to a different space), phone features (containing the duration of context-independent phones that are one-dimensional vectors), and state-in-phone features (containing the sequence of hidden Markov model state durations in the phones). For extraction of these features, state-level alignments from a speech recognizer are used.

For each prosodic feature type, a model is built using the background model data for each occurring word or phone. Speaker models for each word and phone are then obtained through maximum a posteriori (MAP) adaptation of means and weights of the corresponding background model. During testing, three scores are obtained (one for each prosodic feature type). Each of these scores is computed as the sum of the logarithmic likelihoods of the feature vectors in the test speech signal, given its models. This number is then divided by the number of components that were scored. The final score for each prosodic feature type is obtained from the difference between the speaker-specific model score and the background model score. This score may be further normalized, and the three resultant scores may be used in the final combination either independently or after a simple summation of the three scores.

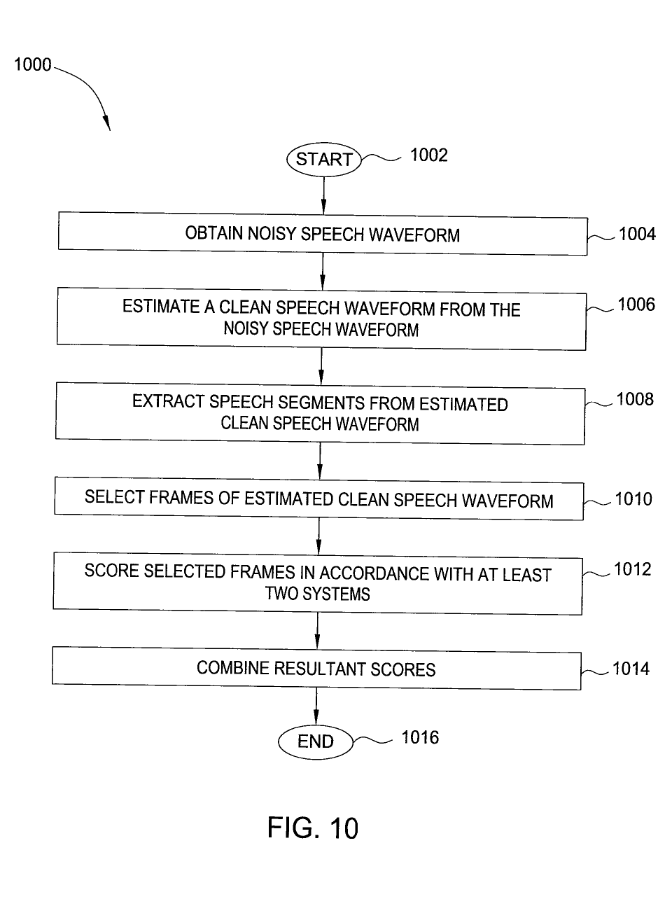

FIG. 10 is a flow diagram illustrating a third embodiment of a method 1000 for speaker recognition, according to the present invention. Specifically, the method 1000 facilitates a variant of the method 1000 that is robust to adverse acoustic conditions (noise).

The method 1000 is initialized at step 1002 and proceeds to step 1004, where the method 1000 obtains a noisy speech waveform (input speech signal).

In step 1006, the method 1000 estimates a clean speech waveform from the noisy speech waveform. In one embodiment, step 1006 is performed in accordance with Wiener filtering. In this case, the method 700 first uses a neural-network-based voice activity detector to mark frames of the speech waveform as speech or non-speech. The method 1000 then estimates a noise spectrum as the average spectrum from the non-speech frames. Wiener filtering is then applied to the speech waveform using the estimated noise spectrum. By applying Wiener filtering to unsegmented noisy speech waveforms, the method 1000 can take advantage of long silence segments between speech segments for noise estimation.

In step 1008, the method 1000 extracts speech segments from the estimated clean speech waveform. In one embodiment, step 1008 is performed in accordance with a speech/non-speech segmenter that takes advantage of the cleaner signal produced in step 1006. In one embodiment, the segmenting is performed by Viterbi-decoding each conversation side separately, using a speech/non-speech hidden Markov model (HMM), followed by padding at the boundaries and merging of segments separated by short pauses.

In step 1010, the method 1000 selects frames of the estimated clean speech waveform for modeling. In one embodiment (e.g., where the speech waveform is scored in accordance with Gaussian mixture modeling), only the frames with average frame energy above a certain threshold are selected. In one embodiment, this threshold is relatively high in order to eliminate frames that are likely to be degraded by noise (e.g., noisy non-speech frames). The actual energy threshold for a given waveform is computed by multiplying an energy percent (EPC) parameter (between zero and one) by the difference between maximum and minimum frame log energy values, and adding the minimum log energy. The optimal EPC (i.e., the parameter for which the test set equal error rate is lowest) is dependent on both noise type and signal-to-noise ration (SNR).

In step 1012, the method 1000 scores the selected frames in accordance with at least two systems. In one embodiment, the method 1000 uses two systems to score the frames: the first system is a Gaussian mixture model (GMM)-based system, and the second system is a maximum likelihood linear regression and support vector machine (MLLR-SVM) system. In one embodiment, the GMM-based system models speaker-specific cepstral features, where the speaker model is adapted from a universal background model (UBM). MAP adaptation is then used to derive a speaker model from the UBM. In one embodiment, the MLLR-SVM system models speaker-specific translations of the Gaussian means of phone recognition models by estimating adaptation transforms using a phone-loop speech model with three regression classes for non-speech, obstruents, and non-obstruents (the non-speech transform is not used). The coefficients from the two speech adaptation transforms are concatenated into a single feature vector and modeled using SVMs. A linear inner-product kernel SVM is trained for each target speaker using the feature vectors from the background training set as negative examples and the target speaker training data as positive examples. In one embodiment, rank normalization on each feature dimension is used.

In step 1014, the method 1000 combines the scores computed in step 1012. In the case where the scoring systems are a GMM-based system and an MLLR-SVM system, the MLLR-SVM system (which is an acoustic model that uses cepstral features, but using non-standard representations of acoustic observations) may provide complementary information to the cepstral GMM-based system. In one embodiment, the scores are combined using a neural network score combiner having two inputs, no hidden layer, and a single linear output activation unit. The method 1000 then terminates in step 1016.

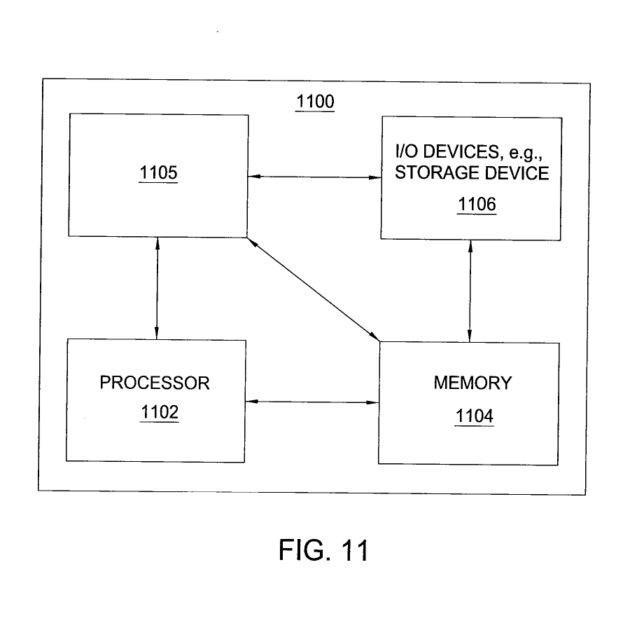

FIG. 11 is a high-level block diagram of the speaker recognition method that is implemented using a general purpose computing device 1100. In one embodiment, a general purpose computing device 1100 comprises a processor 1102, a memory 1104, a speaker recognition module 1105 and various input/output (I/O) devices 1106 such as a display, a keyboard, a mouse, a stylus, a wireless network access card, and the like. In one embodiment, at least one I/O device is a storage device (e.g., a disk drive, an optical disk drive, a floppy disk drive). It should be understood that the speaker recognition module 1105 can be implemented as a physical device or subsystem that is coupled to a processor through a communication channel.

Alternatively, the speaker recognition module 1105 can be represented by one or more software applications (or even a combination of software and hardware, e.g., using Application Specific Integrated Circuits (ASIC)), where the software is loaded from a storage medium (e.g., I/O devices 1106) and operated by the processor 1102 in the memory 1104 of the general purpose computing device 1100. Thus, in one embodiment, the speaker recognition module 1105 for facilitating recognition of a speaker as described herein with reference to the preceding Figures can be stored on a computer readable medium or carrier (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

Although various embodiments which incorporate the teachings of the present invention have been shown and described in detail herein, those skilled in the art can readily devise many other varied embodiments that still incorporate these teachings.

What is claimed is:

1. A method for determining whether a given speech signal is produced by an alleged speaker, where a plurality of statistical models have been produced for the alleged speaker based on a previous speech signal received from the alleged speaker, the plurality of statistical models including at least one support vector machine, the method comprising:
receiving the given speech signal, the speech signal representing an utterance made by a speaker claiming to be the alleged speaker;
scoring the given speech signal using at least two modeling systems, at least one of the at least two modeling systems being a support vector machine;
combining scores produced by the at least two modeling systems, with equal weights, to produce a final score;
determining, in accordance with the final score, whether the speaker is likely the alleged speaker; and
outputting the determination for further use.

2. The method of claim 1, wherein the given speech signal is processed by a word recognizer prior to being received.

3. The method of claim 1, wherein the scoring comprising:
modeling, by each of the at least two modeling systems, different features of the given speech signal.

4. The method of claim 3, wherein at least one of the at least two modeling systems supports acoustic modeling.

5. The method of claim 4, wherein the acoustic modeling comprises:
receiving mean and standard deviations of features of a polynomial feature vector over the given speech signal, the polynomial feature vector representing cepstral features of the given speech signal; and
performing, by a plurality of support vector machines, principal component analysis on the features of the polynomial feature vector for impostor speakers who are not the alleged speaker; and
projecting the features of the polynomial feature vector onto principal components.

6. The method of claim 5, wherein a first pair of support vector machines performs the principal component analysis on a mean polynomial feature vector, and a second pair of support vector machines performs the principal component analysis on the mean polynomial feature vector divided by a standard deviation polynomial vector.

7. The method of claim 5, wherein the polynomial feature vector is produced by:
obtaining Mel frequency cepstral coefficients for the speech signal;
appending the Mel frequency cepstral coefficients with delta and double delta coefficients to produce a preliminary vector;
normalizing the preliminary vector; and
appending the normalized preliminary vector with second order and third order polynomial coefficients to produce the polynomial feature vector.

8. The method of claim 3, wherein at least one of the at least two modeling systems supports prosody modeling

9. The method of claim 8, wherein the prosody modeling comprises:
computing prosodic features over regions defined by prosodic events, the prosodic features being extracted using alignments that are at least one of: word-level alignments, phone-level alignments, or state-level alignments, the alignments being extracted by an automatic speech recognizer, and the prosodic features further being extracted using estimated pitch signals and estimated energy signals; and
modeling the computed prosodic features using at least one of: a support vector machine-based system or a Gaussian mixture model-based system.

10. The method of claim 9, wherein the computed prosodic features are extracted over syllable regions automatically defined using the alignments extracted by the automatic speech recognizer.

11. The method of claim 9, further comprising:
generating a plurality of sequences from the computed prosodic features, each of the plurality of sequences comprising concatenated values corresponding to a number of consecutive regions defined by prosodic events.

12. The method of claim 9, further comprising:
transforming the computed prosodic features into a single signal-level vector, prior to the modeling.

13. The method of claim 12, wherein the transforming comprises:
separately discretizing each computed prosodic feature into a plurality of bins;
concatenating the bin for a number of consecutive slots, the slots comprising at least one of: syllables or pauses;
counting a number of times that each computed prosodic feature or sequence of a number of prosodic features falls into each of the plurality of bins during the given speech signal, to produce a plurality of counts; and
constructing the single signal-level vector in accordance with those of the plurality of counts that correspond to those of the plurality of bins for which a corresponding count is higher than a given threshold.

14. The method of claim 12, wherein the transforming comprises:
training a plurality of background models for a plurality of tokens, each token comprising a subsets of at least one of: features or regions;
obtaining a measure of a distance of the given speech signal with respect to each of the plurality of background models; and
concatenating the obtained distances for each token to form the single signal-level vector.

15. The method of claim 14, wherein the plurality of background models correspond to a plurality of Gaussian mixture models, each of the plurality of tokens corresponds to a {prosodic feature group, pause/non-pause pattern} pair, and each of the measures of distance is given by a posterior probability of Gaussians in the plurality of Gaussian mixture models.

16. The method of claim 3, wherein at least one of the at least two modeling systems supports noise robust modeling.

17. The method of claim 16, wherein the noise robust modeling comprises:
estimating a clean speech waveform from the given speech signal;
extracting speech segments from the estimated clean speech waveform; and
scoring selected frames of the extracted speech segments in accordance with the at least two modeling systems.

18. The method of claim 17, wherein the estimating comprises:
marking frames of the given speech signal as speech or non-speech;
estimating a noise spectrum as an average spectrum from the frames marked as non-speech; and
applying Wiener filtering to the given speech signal, in accordance with the estimated noise spectrum.

19. The method of claim 1, wherein the combining is performed by a combiner support vector machine.

20. The method of claim 1, wherein the support vector machine uses a linear kernel.

21. The method of claim 1, wherein the support vector machine operates under a cost function that makes false rejection more costly than false acceptance.

22. A computer readable medium containing an executable program for determining whether a given speech signal is produced by an alleged speaker, where a plurality of statistical models have been produced for the alleged speaker based on a previous speech signal received from the alleged speaker, the plurality of statistical models including at least one support vector machine, where the program performs the steps of:
receiving the given speech signal, the speech signal representing an utterance made by a speaker claiming to be the alleged speaker;
scoring the given speech signal using at least two modeling systems, at least one of the at least two modeling systems being a support vector machine;
combining scores produced by the at least two modeling systems, with equal weights, to produce a final score;
determining, in accordance with the final score, whether the speaker is likely the alleged speaker; and
outputting the determination for further use.

23. The computer readable medium of claim 22, wherein the given speech signal is processed by a word recognizer prior to being received.

24. The computer readable medium of claim 22, wherein the scoring comprising:
modeling, by each of the at least two modeling systems, different features of the given speech signal.

25. The computer readable medium of claim 24, wherein at least one of the at least two modeling systems supports acoustic modeling.

26. The computer readable medium of claim 25, wherein the acoustic modeling comprises:
receiving mean and standard deviations of features of a polynomial feature vector over the given speech signal, the polynomial feature vector representing cepstral features of the given speech signal; and
performing, by a plurality of support vector machines, principal component analysis on the features of the polynomial feature vector for impostor speakers who are not the alleged speaker; and
projecting the features of the polynomial feature vector onto principal components.

27. The computer readable medium of claim 26, wherein a first pair of support vector machines performs the principal component analysis on a mean polynomial feature vector, and a second pair of support vector machines performs the principal component analysis on the mean polynomial feature vector divided by a standard deviation polynomial vector.

28. The computer readable medium of claim 26, wherein the polynomial feature vector is produced by:
obtaining Mel frequency cepstral coefficients for the speech signal;
appending the Mel frequency cepstral coefficients with delta and double delta coefficients to produce a preliminary vector;
normalizing the preliminary vector; and
appending the normalized preliminary vector with second order and third order polynomial coefficients to produce the polynomial feature vector.

29. The computer readable medium of claim 24, wherein at least one of the at least two modeling systems supports prosody modeling

30. The computer readable medium of claim 29, wherein the prosody modeling comprises:
computing prosodic features over regions defined by prosodic events, the prosodic features being extracted using alignments that are at least one of: word-level alignments, phone-level alignments, or state-level alignments, the alignments being extracted by an automatic speech recognizer, and the prosodic features further being extracted using estimated pitch signals and estimated energy signals; and
modeling the computed prosodic features using at least one of: a support vector machine-based system or a Gaussian mixture model-based system.

31. The computer readable medium of claim 30, wherein the computed prosodic features are extracted over syllable regions automatically defined using the alignments extracted by the automatic speech recognizer.

32. The computer readable medium of claim 30, further comprising:
generating a plurality of sequences from the computed prosodic features, each of the plurality of sequences comprising concatenated values corresponding to a number of consecutive regions defined by prosodic events.

33. The computer readable medium of claim 30, further comprising:
transforming the computed prosodic features into a single signal-level vector, prior to the modeling.

34. The computer readable medium of claim 33, wherein the transforming comprises:
separately discretizing each computed prosodic feature into a plurality of bins;
concatenating the bin for a number of consecutive slots, the slots comprising at least one of: syllables or pauses;
counting a number of times that each computed prosodic feature or sequence of a number of prosodic features falls into each of the plurality of bins during the given speech signal, to produce a plurality of counts; and
constructing the single signal-level vector in accordance with those of the plurality of counts that correspond to those of the plurality of bins for which a corresponding count is higher than a given threshold.

35. The computer readable medium of claim 33, wherein the transforming comprises:
training a plurality of background models for a plurality of tokens, each token comprising a subsets of at least one of: features or regions;
obtaining a measure of a distance of the given speech signal with respect to each of the plurality of background models; and
concatenating the obtained distances for each token to form the single signal-level vector.

36. The computer readable medium of claim 35, wherein the plurality of background models correspond to a plurality of Gaussian mixture models, each of the plurality of tokens corresponds to a {prosodic feature group, pause/non-pause pattern} pair, and each of the measures of distance is given by a posterior probability of Gaussians in the plurality of Gaussian mixture models.

37. The computer readable medium of claim 24, wherein at least one of the at least two modeling systems supports noise robust modeling.

38. The computer readable medium of claim 37, wherein the noise robust modeling comprises:
estimating a clean speech waveform from the given speech signal;
extracting speech segments from the estimated clean speech waveform; and
scoring selected frames of the extracted speech segments in accordance with the at least two modeling systems.

39. The computer readable medium of claim 38, wherein the estimating comprises:
marking frames of the given speech signal as speech or non-speech;
estimating a noise spectrum as an average spectrum from the frames marked as non-speech; and
applying Wiener filtering to the given speech signal, in accordance with the estimated noise spectrum.

40. The computer readable medium of claim 22, wherein the combining is performed by a combiner support vector machine.

41. The computer readable medium of claim 22, wherein the support vector machine uses a linear kernel.

42. The computer readable medium of claim 22, wherein the support vector machine operates under a cost function that makes false rejection more costly than false acceptance.

43. Apparatus for determining whether a given speech signal is produced by an alleged speaker, where a plurality of statistical models have been produced for the alleged speaker based on a previous speech signal received from the alleged speaker, the plurality of statistical models including at least one support vector machine, the apparatus comprising:
means for receiving the given speech signal, the speech signal representing an utterance made by a speaker claiming to be the alleged speaker;
means for scoring the given speech signal using at least two modeling systems, at least one of the at least two modeling systems being a support vector machine;
means for combining scores produced by the at least two modeling systems, with equal weights, to produce a final score;
means for determining, in accordance with the final score, whether the speaker is likely the alleged speaker; and
outputting the determination for further use.
